(19) United States
(12) Patent Application Publication
(10) Pub. No.: US 2011/0056423 A1
(43) Pub. Date: Mar. 10, 2011

(54) POWERED SURFBOARD

(75) Inventor: Mike R. Railey, Del Mar, CA (US)

(73) Assignee: Boomerboard LLC, Branford, CT (US)

(21) Appl. No.: 12/877,857

(22) Filed: Sep. 8, 2010

Related U.S. Application Data
(60) Provisional application No. 61/240,974, filed on Sep. 9, 2009.

(51) Int. Cl. B63B 35/73; B63B 35/79; B63H 21/17; B63H 21/21; G05D 1/00

(52) U.S. Cl. 114/55.56; 441/74; 701/21; 440/1

(57) ABSTRACT

A motorized surfboard comprises top and bottom shells. The top shell comprises recesses that may contain motors, batteries, and motor controllers. The bottom shell comprises recesses that may contain one or more impellers. The impellers may be connected to the motors by shafts that extend through passageways between recesses in the top and bottom shells. The motors may be controlled by the user with various hand, arm, or leg motions. This may be accomplished by providing an accelerometer on the user. Orientation and motion sensed by the accelerometer may be translated to motor commands and these commands may be transmitted wirelessly to the motor controllers.

### CROSS-REFERENCE TO RELATED APPLICATIONS

This application claims the benefit of U.S. Provisional Application No. 61/240,974 filed on Sep. 9, 2009, entitled “POWERED SURFBOARD,” which is hereby incorporated by reference in its entirety.

### BACKGROUND OF THE INVENTION

1. Field of the Invention

The present invention relates to motor driven surfboards.

2. Description of the Related Art

Surfing is the sport of riding a surfboard on the face of an ocean wave towards the shoreline. Jet powered surfboards have been devised and utilized for the purpose of surfing without waves such as in lakes or other calm waters. Several types of motorized water boards in the prior art include U.S. Pat. No. 6,702,634 to Jung; U.S. Pat. No. 6,409,560 to Austin; U.S. Pat. No. 6,142,840 to Efthymiou; U.S. Pat. No. 5,017,166 to Chang; and U.S. Pat. No. 4,020,782 to Gleason. Another powered surfboard design is described in U.S. Pat. No. 7,226,329 to Railey. This device uses small electric motors to provide power while maintaining traditional surfboard performance.

### SUMMARY OF THE INVENTION

In one embodiment, a surfboard comprises a top shell comprising one or more recesses formed therein and a bottom shell coupled to the top shell, where the bottom shell also comprises one or more recesses formed therein. The recesses in the top shell extend generally toward the bottom shell, and the recesses in the bottom shell extend generally toward the top shell. A passageway connects at least one of the one or more recesses in the top shell with at least one of the one or more recesses in the bottom shell. At least one motor may be positioned in at least one of the recesses in the top shell. At least one impeller may be positioned in at least one of the recesses in the bottom shell. The impeller may be coupled to one portion of a shaft, another portion of the shaft may be coupled to the motor, and wherein the shaft extends through the passageway.

In another embodiment, a method of making a surfboard comprises affixing a top shell to a bottom shell to form a surfboard body, placing at least one motor in at least one recess in the top shell, placing at least one impeller in at least one recess in the bottom shell, and coupling the impeller to the motor.

In another embodiment, a system for controlling a powered surfboard comprises an accelerometer, a processor coupled to the accelerometer, and a radio transmitter coupled to the processor. The processor is configured to receive output from the accelerometer, determine motor control commands based, at least in part, on the output from the accelerometer, and transmit motor control commands to a motorized surfboard via the radio transmitter. The system may comprise a housing for the accelerometer, processor, and radio transmitter. The housing may be integrated into a glove, a wrist strap, or an ankle strap.

### BRIEF DESCRIPTION OF THE DRAWINGS

FIG. 1 is an exploded view of a top shell of a surfboard showing components placed in top shell recesses.

FIG. 2 is an exploded view of a bottom shell of a surfboard showing components placed in bottom shell recesses.

FIG. 3 is a cutaway view of a surfboard made from top and bottom shells with power components mounted therein in accordance with one embodiment of the invention.

FIG. 4 shows a detailed view of a passageway between a motor recess in a top shell and an impeller recess in a bottom shell.

FIG. 5 is a perspective view of a flow housing in which the impeller may be inserted.

FIG. 6 illustrates the bottom shell attached to the top shell in the region of the surfboard tail with one flow housing attached in one of the bottom shell recesses.

FIG. 7 is a block drawing showing one embodiment of a drive control system, which may be used in one embodiment of the motorized surfboard.

FIG. 8 is a flow chart illustrating a method for use with one embodiment of the motorized surfboard

FIG. 9 is a flow a top view of one embodiment of a drive control system, which may be used in one embodiment of the motorized surfboard.

### DETAILED DESCRIPTION OF THE PREFERRED EMBODIMENT

Traditionally, the sport of surfing comprises a rider (“surfer”) paddling out by lying prone on the surfboard and paddling away from the shoreline towards a point at which waves are cresting; turning to face the shoreline; paddling quickly towards the shoreline when a wave begins to crest so as to catch the wave; and riding the wave on the surfboard propelled by the wave towards the shoreline in a prone, sitting or standing position. When riding a wave, a surfer may turn the surfboard towards or away from different parts of the cresting wave depending on the preference and skill of the surfer. Subsequently, the surfer must paddle out and repeat the process of catching and riding waves. After catching and riding waves for a period of time, the surfer may ride a wave all the way to the shoreline, or may paddle in by lying prone on the surfboard and paddling towards the shoreline. Paddling out, turning, paddling quickly to catch waves can be tiring and time consuming to the surfer and can thus limit the surfer's energy and time for riding waves. Advantageous embodiments of the present invention preserve a surfer's maximum energy for riding waves rather than exhausting the surfer's energy on paddling. In addition, embodiments of the invention help a surfer catch larger and faster waves easier.

The general purpose of many embodiments described herein is to provide a motorized surfboard which can be manufactured in a less labor intensive manner, has minimal problems with leakage and long term reliability.

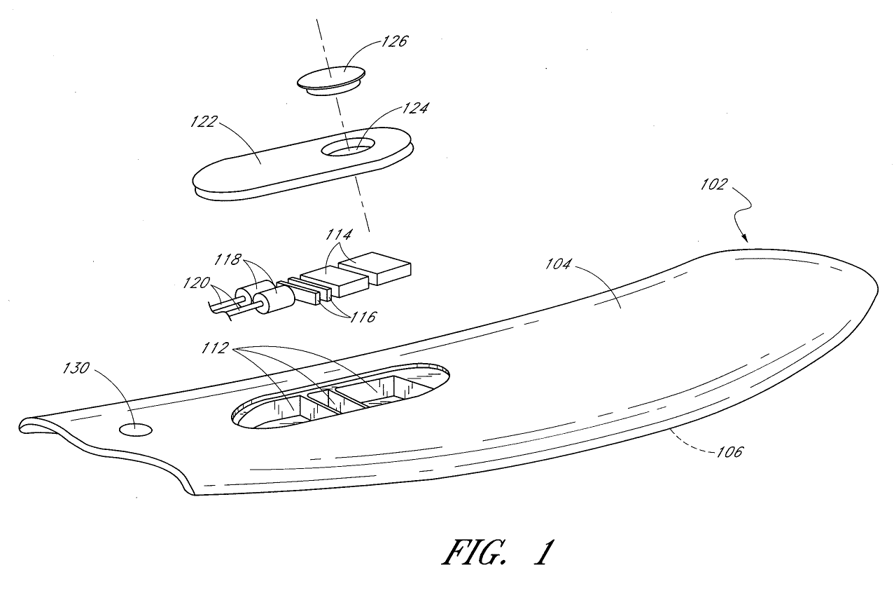

Referring now to FIGS. 1, 2, and 3, in advantageous embodiments, a motorized surfboard comprises a top shell 102, and a bottom shell 202. This hollow shell construction has been recently utilized for surfboard manufacture, and represents a departure from traditional shaped foam boards. It is one aspect of the invention that this hollow shell design has been adapted to a motorized surfboard in a manner that minimizes manufacturing costs and provides structural integrity and long term reliability.

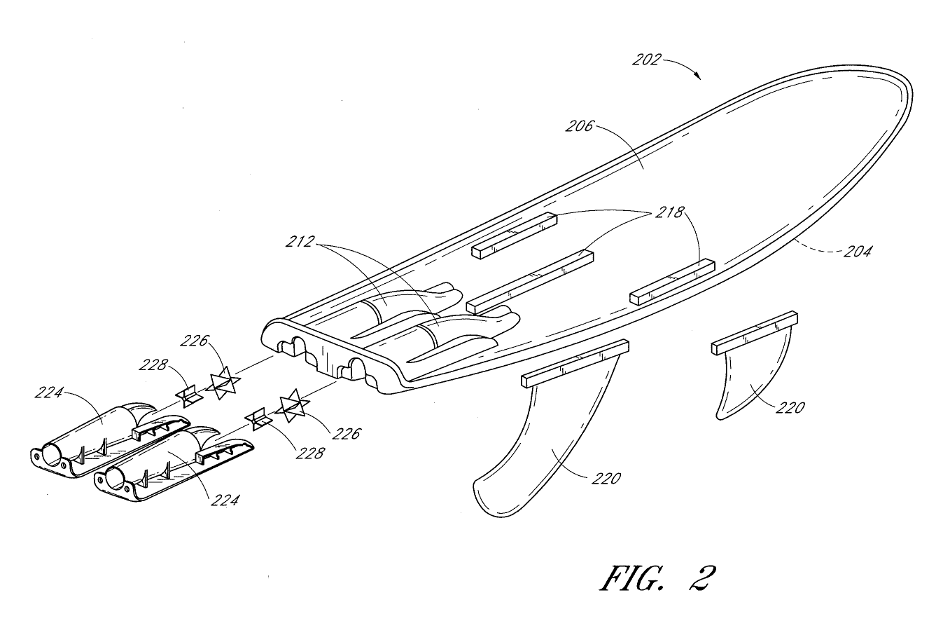

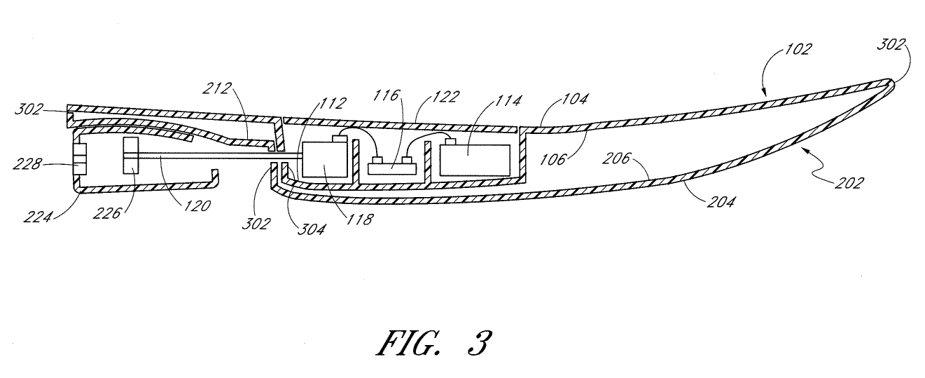

The top shell 102 is illustrated in FIG. 1, and the bottom shell 202 is illustrated in FIG. 2. In FIG. 3, a conceptual cutaway view is provided showing how the shells mate with each other in an especially advantageous embodiment.

The top shell 102 has an outer surface 104, and an inner surface 106. Similarly, the bottom shell has an outer surface 204, and an inner surface 206. To produce the complete surfboard body, the two shells are sealed together along a seam 302 that extends around the periphery of the top and bottom shells. The “outer surface” of the top and bottom shells are the surfaces that are contiguous with the surfaces exposed to the water in use (although not all of the “outer surface” of the shells is actually exposed to water as will be seen further below). The “inner surface” of the top and bottom shells are the surfaces internal to the hollow board after sealing into a hollow surfboard body. The general methods of producing surfboards with this hollow shell technique are known in the art. Currently, Aviso Surfboards (www.avisosurf.com) manufactures surfboards in this manner from carbon fiber top and bottom shells forming a hollow surfboard body.

The outer surface 104 of the top shell 102 is formed with one or more recessed portions 112, where the recessed portions extend generally toward the inner surface 206 of the bottom shell 202 when the shells are sealed together into a hollow body. The recessed portions 112 form compartments for batteries 114, motor controller boards 116, and motors 118. The motors 118 are coupled to shafts 120 that extend out the rear of the motor compartment as will be explained further below.

After installation of these components, the recesses can be sealed with a cover 122 that can be secured in place with adhesive such as caulking or other water resistant sealant. If desired, an internally threaded access port 124 can be provided that receives an externally threaded cover 126. This can provide easier access than removing or cutting the adhesive on the larger cover 122. In some advantageous embodiments, one or both of the covers 122, 126 are clear so that the batteries, motors, and/or other electronics can be seen when they surfboard is sealed up and in use. Another threaded plug 130 can also be provided, which can be used to ensure equal air pressures on the inside and outside of the hollow body. This feature is well known and normally utilized for hollow shell surfboards.

Turning now to FIG. 2, the outer surface 204 of the bottom shell 202 also includes one or more recessed portions 212, where the recessed portions extend generally toward the inner surface 106 of the top shell 102 when the shells are sealed together into a hollow surfboard body. The bottom shell 202 may also contain recesses 218 for fin boxes that accept fins 220 in a manner known in the art. The bottom shell recesses 212 are configured to accept pump housings 224. As shown in FIG. 3, the pump housings 224 receive the motor shafts 120, onto which an impeller 226 is attached. At the rear of the pump housing 224, a flow straightener 228 may be attached.

As shown in FIG. 3, the recessed portion 112 in the top shell and the recessed portion 212 in the bottom shell comprise walls 302 in the bottom shell and 304 in the top shell that are proximate to one another. In advantageous embodiments, these proximate walls extend approximately perpendicular to the overall top and bottom surfaces of the surfboard. In these proximate walls are substantially aligned openings, through which the motor shaft 120 extends. Thus, the motor(s) 118, which reside in a recessed portion of the top shell, are coupled to the impeller(s) that reside in the pump housing(s) that in turn reside in a recessed portion of the bottom shell.

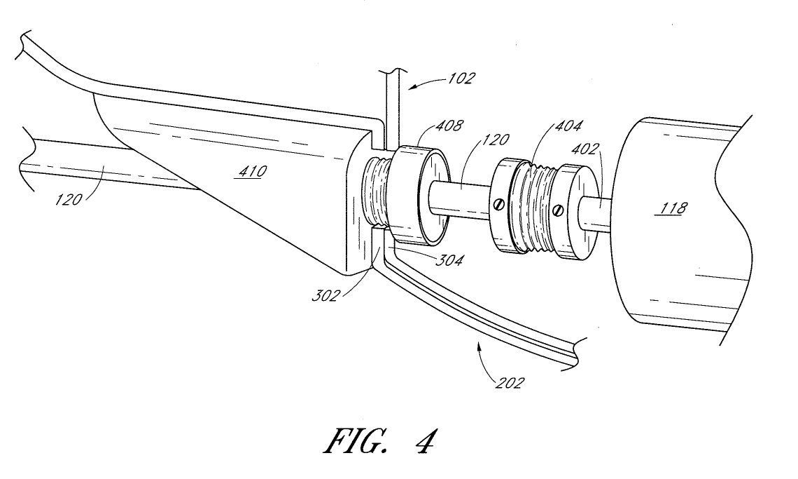

FIG. 4 illustrates in more detail the surfaces 302 and 304 through which the motor shaft 120 extends. Typically, the motor 118 includes an integral shaft 402 of fairly short extent. This short shaft may be coupled to a longer extended motor shaft 120 with a bellows coupler 404. These couplers 404 are commercially available, from for example, Ruland, as part number MBC-19-6-6-A. The bellows coupling 404 is advantageous because it allows for smooth shaft rotation even in the presence of vibrations and/or small deviations in linearity of the connection. The long shaft 120 then extends through a bearing 408 which has a threaded rear portion. The threaded rear portion of the bearing 408 is threaded into a threaded insert 410 that is positioned on the other side of the openings, in the recessed portion of the bottom shell. When the bearing is tightened into the insert, a water tight seal is created as the walls 302 and 304 are compressed together. It will be appreciated that the walls 302, 304 may directly touch, or they may remain separated, with or without additional material between. To further minimize any potential for leakage, it is possible to place washers of rubber, polymer, or the like between the insert 410 and the wall 320, and/or between the bearing 408 and the wall 304.

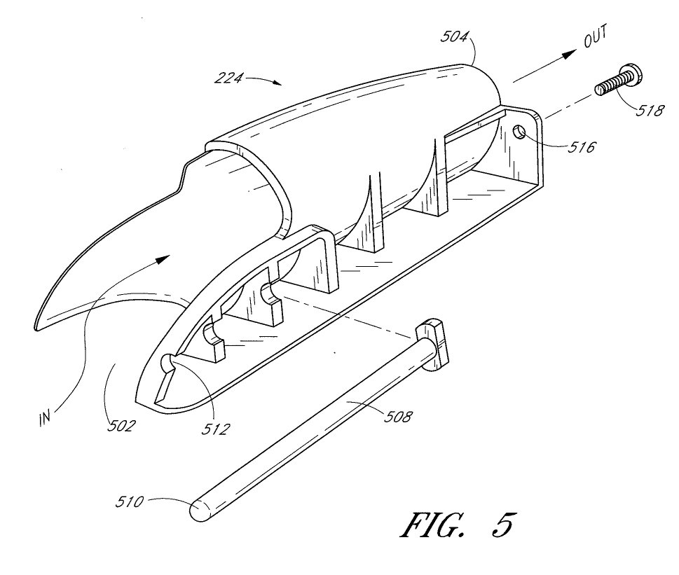

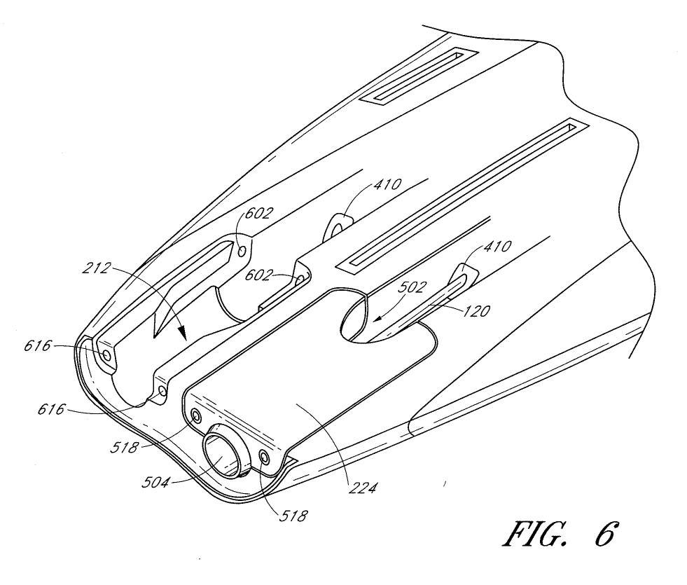

FIGS. 5 and 6 illustrate the positioning of the pump housing 224 in the recessed portion 212 of the bottom shell. FIG. 5 illustrates the underside of the pump housing 224 and FIG. 6 illustrates a pump housing installed in a recess of the bottom shell. The pump housing 224 is basically a hollow tube for directing water up to the impeller and out the rear of the surfboard. Thus, the pump housing comprises an inlet port 502 and an exhaust port 504. The pump housing 224 can be secured in the recess 212 in a variety of ways. The embodiment of FIGS. 5 and 6 includes shafts 508 that are secured to each side of the pump housing. The tip 510 of the shaft 508 extends through an opening 512 in the frontward of the pump housing 224. Referring now to FIG. 6, these exposed tips 510 are placed in holes 602 in the recess to secure the pump housing into the frontward portion of the recess 212. The rear of the pump housing may comprise a wall with holes that mate with holes 616 in the bottom shell. The holes in the bottom shell may be provided with press fit threaded inserts. Screws 518 can then be used to secure the rear of the pump housing 224 to the rear of the recess 212.

It will be appreciated that the pump housing 224 can be secured in the recess 212 in a variety of ways. For example, instead of having holes in the bottom shell for screws and pins, slots and/or blind recesses can be formed in or adhesively attached to the side surfaces of the recess that engage mating surfaces on the pump housing. Such structures can also be provided with threads for engaging screw connections. As another alternative, adhesive could be used to secure the pump housing in place.

Turning now to the power and control electronics and devices illustrated in FIGS. 1 and 3, a wide variety of power sources, motor controllers, and motors may be utilized. They can be secured in their respective recesses on metal frames and/or plates (not shown) that are secured in the recesses with adhesive and/or with fasteners such as screws to structures in the recesses integral to the side walls or adhesively secured thereto. Acceptable sources of power include a lithium battery or plurality of lithium batteries.

To avoid a hard wired connection to the motor controllers 116 from a throttle control input, the motor controller 116 advantageously include a wireless receiver. This receiver can communicate with a wireless transmitter that is controlled by the surfer in order to control the motor speed. Wireless throttle controls have been used extensively, but using a throttle while surfing poses unique issues in that paddling, standing, and riding waves will interfere with a surfer's ability to easily manipulate a control mechanism such as a trigger, a dial, or the like. In one embodiment, wireless transmission circuitry can be configured to transmit electromagnetic and/or magnetic signals underwater. Because one or both transmitter and receiver can be under the surface of the ocean during much of the duration of surfing, a transmission system and protocol that is especially reliable in these conditions may be used. For example, wireless circuitry can be implemented in accordance with the systems and methods disclosed in U.S. Pat. No. 7,711,322, which is hereby incorporated by reference in its entirety. As explained in this patent, it can be useful to use a magnetically coupled antenna operating in a near field regime. A low frequency signal, e.g. less than 1 MHz, can further improve underwater transmission reliability. With this type of throttle system, an automatic shut off may be implemented, where if the signal strength between the transmitter and receiver drops below a certain threshold, indicating a certain distance between the two has been exceeded, the receiver shuts off the electric motor. This is useful as an automatic shut off if the surfer falls off the board.

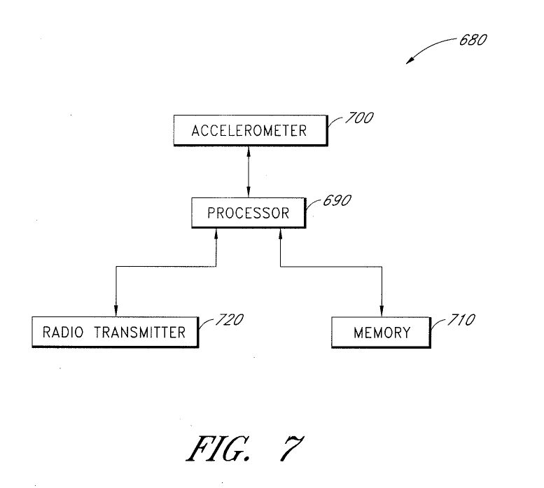

FIG. 7 illustrates an alternative control mechanism 680 for controlling a motorized surfboard. Control mechanism 680 has a processor 690 for coordinating the operation of the control mechanism 680. The processor 690 is coupled to an accelerometer 700. The accelerometer 700 measures acceleration. These measurements are communicated to processor 690. Processor 690 may also communicate with accelerometer 700 for the purpose of initializing or calibrating accelerometer 700. In one embodiment, accelerometer 700 is a 3-axis accelerometer and can measure acceleration in any direction. Processor 690 is also coupled to memory 710. In one example, memory 710 is used to store patterns or profiles of accelerometer readings which have been associated with particular motor control commands. For example, memory 710 may store a pattern of accelerometer readings which has been previously associated with a command to cause the motor controller to activate the motors. The processor 690 can compare the current accelerometer 700 outputs to the previously stored profiles to determine whether the current outputs should be interpreted as a motor command. Control mechanism 680 also has a radio transmitter 720 coupled to the processor 690. In one embodiment, radio transmitter 720 transmits information received from processor 690, such as motor commands, to radio receiver 504.

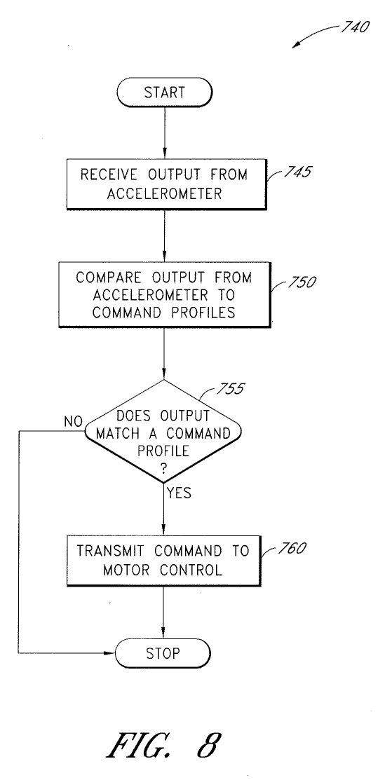

FIG. 8 illustrates a method 740 for using control mechanism 680, consistent with one embodiment of the invention. At step 745, output is received from the accelerometer. In one embodiment, the output from the accelerometer may be an analog signal representative of the acceleration measured along each axis measured by the accelerometer. In another embodiment, an analog to digital converter may be used to convert the output to a digital representation of the analog signal. Alternatively, the accelerometer may be configured to output digital signals. For example, the accelerometer itself may be configured to output a digital pulse when the acceleration detected on each axis exceeds some threshold amount.

After the output from the accelerometer is received, the control mechanism compares the output to pre-determined command profiles as show in step 750. These command profiles may also be referred to as accelerometer output patterns or simply as patterns. For example, the control mechanism may store a pattern corresponding to a repeated positive and negative acceleration substantially along a particular axis. Another pattern may correspond to an isolated positive acceleration along a particular axis. The patterns of accelerometer outputs may be associated with particular commands for the motor controllers. For example one pattern may correspond to a command to activate a subset of the available motors. Another pattern may correspond to a command to activate one or more available motors with a particular duty cycle or at a particular percentage of maximum operation potential.

The comparison of the current accelerometer output to the command profile results in a determination of whether the output matches a particular command profile, as shown in step 755. In one embodiment, if the current output does not match a command profile, the output from the accelerometer is discarded and the method concludes, leaving the control mechanism to wait for more output from the accelerometer. However, if the current output does match a command profile, the control mechanism transmits the corresponding command to the motor controllers, as shown in step 760. After the transmission, the command mechanism may again wait for additional output from the accelerometer.

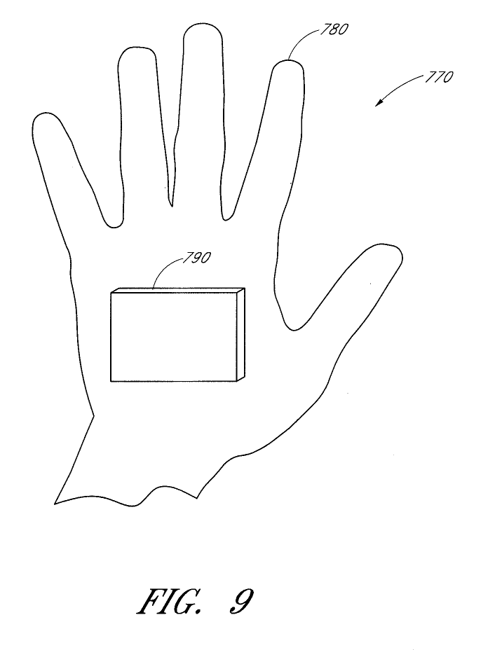

In alternative embodiments, the control mechanism may operate without the need for pattern comparison. For example, in one embodiment, the control mechanism may be configured to interpret accelerometer readings as a proxy for throttle control. In one embodiment, the magnitude and duration of the accelerometer output may be directly translated into magnitude and duration signals for the motor controllers. For example, an acceleration reading above a particular threshold may be interpreted as a command to activate the motors. The duration of the command may be a proportional to the duration for which the acceleration reading is received. FIG. 9 illustrates one possible embodiment for the control mechanism 680. In this embodiment the control mechanism is encapsulated in a package 790 which is integrated into a glove 780. It will be appreciated by one of ordinary skill in the art that the term integrated into the glove may comprise being attached to the surface or within the structure of glove 780. In one embodiment the package 790 is a water tight package. In one embodiment, package 790 comprises a plastic box. In another embodiment, package 790 comprises layers of fabric or other materials. Advantageously this embodiment facilitates control of the motorized surfboard while maintaining the ability of the surfer to use his hands for normal surfing activity. For example, rather than positioning one hand on throttle 620 to control the motorized surfboard, the normal motion of the surfer's hand, while wearing the glove, may be used to control the motorized surfboard. For example, it may be desirable for the motor controller to activate the motors while the surfer would normally be paddling. This may be when the surfer is paddling out or when the surfer is attempting to position himself to catch a wave. Accordingly, when the control mechanism is embed in a glove, 780, the control mechanism may be configured to recognize the acceleration experienced by a surfer's hand during the paddling motion as a command to engage the motors. Thus, the surfer is free to use his hands for normal surfing activity while the control mechanism activates the motors when the surfer's hand motions indicate that the surfer is performing an activity which would be aided by additional motor support. Alternatively, the control mechanism may be configured to activate the motors in response to patterns which, though not necessarily surfing related, require less effort or distraction than involved in manually manipulating a throttle. For example, while riding a wave, rather than adjusting a throttle, the surfer wearing glove 780 might simply shake his hand to engage or disengage the motor. Accordingly, the surfer is able to control the motors of the surfboard with less effort and coordination than would be required to manipulate the throttle embedded in body of the surfboard. Further, the control mechanism may be configured to automatically deactivate the motors in response to a decrease in signal strength between the receiver and a transmitter encapsulated in box 790. For example, the control mechanism may be configured to deactivate the motors when a surfer falls off of the surfboard and becomes separated therefrom. In an alternative embodiment, the packaged control mechanism 790 may also be attached to or integrated into a wrist strap of other clothing or accessory. In another embodiment, a glove 780 or other accessory or clothing may be worn on each hand and each corresponding control mechanism may control a different subset of motors in the motorized surfboard.

What is claimed is:

1. A surfboard comprising:
a top shell comprising one or more recesses formed therein;
a bottom shell coupled to said top shell, said bottom shell comprising one or more recesses formed therein;
wherein said recesses in said top shell extend generally toward said bottom shell;
wherein said recesses in said bottom shell extend generally toward said top shell; and
a passageway connecting at least one of said one or more recesses in said top shell with at least one of said one or more recesses in said bottom shell.

2. The surfboard of claim 1, comprising at least one motor positioned in at least one of said recesses in said top shell.

3. The surfboard of claim 2, comprising an impeller positioned in at least one of said recesses in said bottom shell.

4. The surfboard of claim 3, wherein said impeller is positioned in a flow housing, and wherein said flow housing is positioned in said recess.

5. The surfboard of claim 4, wherein said impeller is coupled to one portion of a shaft, wherein another portion of said shaft is coupled to said motor, and wherein said shaft extends through said passageway.

6. The surfboard of claim 5, wherein said shaft is coupled to said motor through a bellows coupler.

7. The surfboard of claim 5, wherein said passageway comprises a bearing and a bushing.

8. The surfboard of claim 2, wherein at least one battery is positioned in at least one of said recesses in said top shell.

9. The surfboard of claim 8, wherein at least one motor controller is positioned in at least one of said recesses in said top shell.

10. The surfboard of claim 2, wherein at least one motor controller is positioned in at least one of said recesses in said top shell.

11. The surfboard of claim 1, wherein a side of at least one of said recesses in said top shell is adjacent to a side of at least one of said recesses in said bottom shell.

12. The surfboard of claim 11, wherein said passageway comprises mating holes in said adjacent sides.

13. The surfboard of claim 12, comprising at least one motor positioned in one of said recesses in said top shell.

14. The surfboard of claim 13, comprising an impeller positioned in one of said recesses in said bottom shell.

15. The surfboard of claim 14, wherein said impeller is positioned in a flow housing, and wherein said flow housing is positioned in said recess.

16. The surfboard of claim 14, comprising a shaft coupling said motor to said impeller, wherein said shaft extends through said passageway.

17. A method of making a surfboard, said method comprising:
affixing a top shell to a bottom shell to form a surfboard body;
placing at least one motor in at least one recess in said top shell;
placing at least one impeller in at least one recess in said bottom shell; and
coupling said impeller to said motor.

18. The method of claim 17, comprising forming a passageway connecting said at least one recess in said top shell and said at least one recess in said bottom shell.

19. The method of claim 18, comprising coupling said impeller to said motor through said passageway.

20. The method of claim 17, comprising placing foam inside said surfboard body.

21. The method of claim 17, comprising placing at least one battery in at least one recess in said top shell.

22. The method of claim 21, comprising placing at least one motor controller in at least one recess in said top shell.

23. The method of claim 22, comprising coupling said at least one battery to said at least one motor controller, and coupling said at least one motor controller to said at least one motor.

24. A system for controlling a powered surfboard, the system comprising:
an accelerometer;
a processor coupled to the accelerometer; and
a radio transmitter coupled to the processor;
wherein the processor is configured to:
receive output from the accelerometer;
determine motor control commands based, at least in part, on the output from the accelerometer; and
transmit motor control commands to a motorized surfboard via the radio transmitter.

25. The system of claim 24, further comprising a memory coupled to the processor, wherein the processor is configured to compare output from the accelerometer to a pattern stored in the memory.

26. The system of claim 24, further comprising a housing for the accelerometer, processor, and radio transmitter.

27. The system of claim 26, further comprising a glove, wherein the housing is integrated into the glove.

28. The system of claim 26, further comprising a wrist strap, wherein the housing is integrated into the wrist strap.

29. The system of claim 26, further comprising an ankle strap, wherein the housing is integrated into the wrist strap.

30. A method for controlling a motorized surfboard, the method comprising:
receiving an output from an accelerometer;
determining a motor command based at least in part on the output from the accelerometer; and
transmitting the motor command to a motor controller of a motorized surfboard.

31. The method of claim 30, wherein determining a motor command comprises comparing the output to a pre-determined pattern having an associated motor command.

32. The method of claim 30, wherein the pattern corresponds to an accelerometer reading for acceleration experienced by a hand of a surfer while paddling.
